(19) United States
(12) Patent Application Publication
(10) Pub. No.: US 2008/0072033 A1
(43) Pub. Date: Mar. 20, 2008

(54) Re-encrypting policy enforcement point

(76) Inventor: Donald McAlister, Apex, NC (US)

Correspondence Address: HAMILTON, BROOK, SMITH & REYNOLDS, P.C., 530 VIRGINIA ROAD, P.O. BOX 9133, CONCORD, MA, 01742-9133, US

(21) Appl. No.: 11/523,760

(22) Filed: Sep. 19, 2006

(51) Int. Cl. H04L 9/00

(52) U.S. Cl. 713/153; 713/160

(57) ABSTRACT

Providing end-to-end security poses many challenges to security solutions. In Internet Security (IPsec), securing data locally and remotely, as well as reducing the number of security associations and polices needed to secure that data are such challenges. The provided method and apparatus answer theses challenges by i) decrypting an encrypted packet according to a first policy, ii) establishing a local secure connection to an end node on a local network according to a second security policy in an event a source and a destination of the packet belong to a same security group, and the destination of the packet is on the local network, and iii) establishing a remote secure connection to a remote network according to a third security policy in an event the source and the destination of the packet belong to a same security group, and the destination of the packet is the remote network.

### BACKGROUND OF THE INVENTION

### Existing Network Security Technology

Computer network traffic is normally sent unsecured without encryption or strong authentication by a sender and a receiver. This allows the traffic to be intercepted, inspected, modified or redirected. Either the sender or the receiver can falsify their identity. In order to allow private traffic to be sent in a secure manner, a number of security schemes have been proposed and are in use. Some are application dependent, as with a specific program performing password authentication. Others such as (TLS) are designed to provide comprehensive security to whole classes of traffic such as Hypertext Transfer Protocol (HTTP) (i.e., web pages) and File Transfer Protocol (FTP), i.e., files.

Internet Security (IPsec) was developed to address a broader security need. As the majority of network traffic today is over Internet Protocol (IP), IPsec was designed to provide encryption and authentication services to this type of traffic regardless of the application or the transport protocol. This is done in IPsec tunnel mode by encrypting a data packet (if encryption is required), performing a secure hash (authentication) on the packet, then wrapping the resulting packet in a new IP packet indicating it has been secured using IPsec.

The secrets and other configurations required for this secure tunnel must be exchanged by the involved parties to allow IPsec to work. This is done using Internet Key Exchange (IKE). IKE key exchange is done in two phases.

In a first phase (IKE Phase 1), a connection between two parties is started in the clear. Using public key cryptographic mechanisms, where two parties can agree on a secret key by exchanging public data without a third party being able to determine the key, each party can determine a secret for use in the negotiation. Public key cryptography requires each party either share secret information (pre-shared key) or exchange public keys for which they retain a private, matching, key. This is normally done with certificates, e.g., Public Key Infrastructure (PKI). Either of these methods authenticates the identity of the peer to some degree.

Once a secret has been agreed upon in IKE Phase 1, a second phase (IKE Phase 2) can begin where the specific secret and cryptographic parameters of a specific tunnel are developed. All traffic in phase 2 negotiations is encrypted by the secret from phase 1. When these negotiations are complete, a set of secrets and parameters for security have been agreed upon by the two parties and IPsec secured traffic can commence. When a packet is detected at a Security Gateway (SGW) with a source/destination pair which requires IPsec protection, the secret and other Security Association (SA) information are determined based on the Security Policy Database (SPD) and IPsec encryption and authentication is performed. The packet is then directed to an SGW which can perform decryption. At the receiving SGW, the IPsec packet is detected, and its security parameters are determined by a Security Parameter Index (SPI) in the outer header. This is associated with the SA, and the secrets are found for decryption and authentication. If the resulting packet matches the policy, it is forwarded to the original recipient.

Although IPsec tunnel mode has been used effectively in securing direct data links and small collections of gateways into networks, a number of practical limitations have acted as a barrier to more complete acceptance of IPsec as a primary security solution throughout industry.

### General Limitations of IPsec

Configuration of Policies—Each SGW must be configured with each pair of source and destination IP addresses or subnets which must be secured (or allowed in the clear or dropped). For example, if there are 11 SGW units fully meshed, each protecting 10 subnets, this requires 1000 policies in the SPD. This is a challenge in terms of the user setting up the policies, the time required to load the policies, the memory and speed difficulties in implementing the policies, and the increase in network time spent performing negotiations and rekey. The time for initial IKE negotiations in this example might be 10 minutes or more. In addition, even for smaller networks, it requires the user to have a complete knowledge of all protected subnets and their security requirements. Any additions or modifications must be implemented at each gateway.

### Challenges Specific to End-To-End Security

Local network security—One of the most significant barriers to general acceptance of IPsec as a security solution is the challenge of securing the data as it leaves a computer on a local network to when it enters a computer on a remote network. This level of security, combined with authentication and authorization on each side, would extend security from just covering the WAN (e.g., the Internet) to protecting data from unauthorized local or internal access.

Some of the general limitations of IPsec are exacerbated by end-to-end deployment. For example, the IPsec implementation cannot be place on the WAN side of the firewall, IDS, NAT device, or any load balancing device between virtual servers. There are a number of hurdles to true end-to-end security in addition to the general limitations described above.

Installation of an IPsec/IKE Stack on Individual PCs—With the variety of available operating systems (e.g., Windows XP, XP Service Pack 1 and 2, Linux and all it's kernel releases, etc.) and hardware platforms, a software implementation of the IPsec stack, which is dependent on both of these, must be designed, compiled, tested, and supported for each implementation.

Hardware solutions, such as IPsec on a Network Interface care (NIC), provide some separation from these issues, but preclude automated remote installation of the IPsec stack.

In addition, a computer installed with an IPSsec stack must be configured with a user certificate and a policy configuration. Ideally, the user would be identified in some way other than a machine based certificate. Unfortunately, all existing implementations require the computer to be configured directly, normally by a network security manager. IKE offers methods for remote access using certificate based authentication combined with Remote Authentication Dial-In User Service (RADIUS) and X Authority (XAUTH) for the user ID as well as a mode configuration to supply the user with a local network identification.

Limitation in Ability to Provide High-Speed, Low Latency, and High Number of SAs and Policies—A software solution on a computer (or a mobile device) would be unable to provide high speed encryption or latency as low as on an existing SGW. In some cases this does not matter, but in situations with a high speed connection or involving streaming data, high speed encryption and/or low latency may be significant. A hardware solution may suffer this limitation as well due to heat, space, or power considerations.

Both software and hardware solutions may be limited in the number of SAs or policies which are supported. This could be critical in a large, fully meshed security situation.

### SUMMARY OF THE INVENTION

For purposes of explaining aspects of various embodiments of the present invention, the following terms are defined and used herein:

Securing” implies both encrypting data in transit and authenticating that data to ensure that the data has not been manipulated in transit.

A “secure tunnel” between two devices ensures that data passing between the two devices is secured.

A “security policy” (or simply “policy”) for a secure tunnel defines data (or “traffic”) to be secured by a source IP address, a destination IP address, a port number and/or a protocol. The security policy also defines a type of security to be performed.

A “key” for a secure tunnel is a secret information used to encrypt or to decrypt (or to authenticate and to verify) data in one direction of traffic in the secure tunnel.

A “security group” (SG) is a collection of member end-nodes or subnets which are permitted to access or otherwise communicate with one another. A security policy may be configured with a security group and end nodes associated with that group. Further details of a preferred embodiment for configuring and distributing a security policy with a security group are contained in a co-pending U.S. Provisional Patent Application No. [60/836,173] entitled MULTIPLE SECURITY GROUPS WITH COMMON KEYS ON DISTRIBUTED NETWORKS, filed Aug. 8, 2006, assigned to CipherOptics, Inc., and which is hereby incorporated by reference in its entirety.

Embodiments of the present invention provide a method and an apparatus for reducing a number of security policies and Security Associations (SAs) required for providing local network security and remote network security. More specifically, a network security method provides local network security and remote network security by: i) decrypting an encrypted packet according to a first security policy to yield a decrypted packet; ii) establishing a local secure connection to an end node on a local network according to a second security policy in an event a source of the decrypted packet and a destination of the decrypted packet belong to a same security group, and the destination of the decrypted packet is on the local network; and iii) establishing a remote secure connection to a remote network according to a third security policy in an event the source of the decrypted packet and the destination of the decrypted packet belong to a same security group, and the destination of the decrypted packet is the remote network.

In establishing the local secure connection to the end node, the network security method encrypts the decrypted packet with a set of local security parameters. Similarly, in establishing the remote secure connection to the remote network the network security method encrypts the decrypted packet with a set of remote security parameters.

In one embodiment, the network security method also drops the decrypted packet in an event the source of the decrypted packet and the destination of the decrypted packet belong to different security groups and a network only allows encrypted packets.

In yet another embodiment, the network security method: i) passes the decrypted packet unencrypted to the end-node on the local network in an event the source of the decrypted packet and the destination of the decrypted packet belong to different security groups, and the local network allows unencrypted packets; and ii) passes the decrypted packet unencrypted to the remote network in an event the source of the decrypted packet and the destination of the decrypted packet belong to different security groups, and the remote network allows unencrypted packets.

### BRIEF DESCRIPTION OF THE DRAWINGS

The foregoing and other objects, features and advantages of the invention will be apparent from the following more particular description of preferred embodiments of the invention, as illustrated in the accompanying drawings in which like reference characters refer to the same parts throughout the different views. The drawings are not necessarily to scale, emphasis instead being placed upon illustrating the principles of the invention.

FIG. 1 is a network diagram of example wide area data communications network implementing an embodiment of the present invention;

FIG. 2 is a block diagram of an example R-PEP function in accordance with an embodiment of the present invention;

FIG. 3 is a flow diagram of an example process for securing a local network and a remote network in accordance with an embodiment of the present invention; and

FIGS. 4A and 4B are flow diagrams of example R-PEP processes processing encrypted packets from a local network and a remote network while providing local network security and remote network security in accordance with embodiments of the present invention.

### DETAILED DESCRIPTION OF THE INVENTION

A description of preferred embodiments of the invention follows.

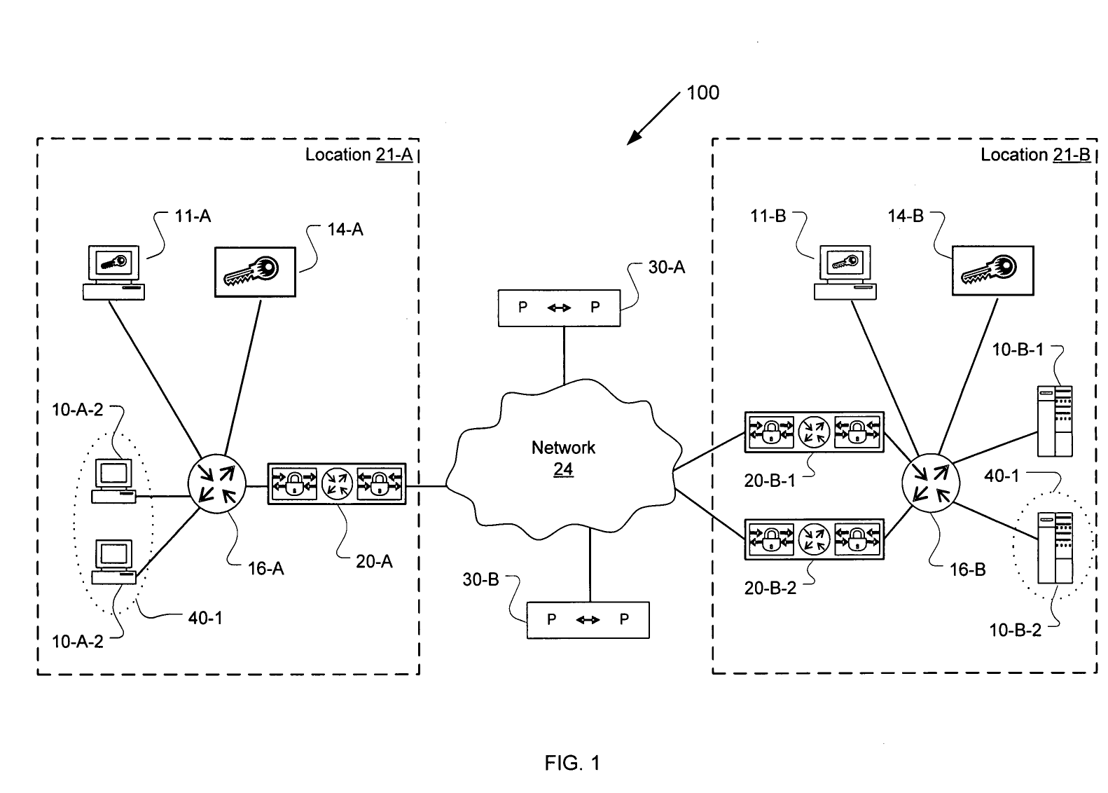

FIG. 1 illustrates an example wide area data communications network 100 implementing an embodiment of the present invention. In the network 100, a location 21-a generally has a number of data processors and functions including end nodes 10-a-1 and 10-a-2, a Security Manager (SM) function 11-a, a Key Authority Point (KAP) (also referred to as Key Generation and Distribution Point (KGDP)) function 14-a, an inter-networking device 16-a, such as a router or a switch, a Re-encrypting Policy Enforcement Point (R-PEP) function 20-a, and a Policy Distribution Point (PDP) function 30-a.

Typically, the network 100 has at least one other location 21-b which implements end nodes 10-b-1 and 10-b-2, a SM function 11-b, a KAP function 14-b, R-PEP functions 20-b-1 and 20-b-2, and a PDP function 30-b.

Locations 21-a and 21-b may be subnets, physical LAN segments or other network architectures. What is important is the locations 21-a and 21-b are logically separate from one another and from other locations 21. A location 21 may be a single office of an enterprise which may have only several computers. In contrast a location 21 may be a large building, complex or campus which has many different data processing machines installed therein. For example, location 21-a may be a west coast headquarters office located in Los Angeles and the location 21-b may be an east coast sales office located in New York.

The end nodes 10-a-1, 10-a-2, 10-b-1, 10-b-2 . . . (collectively, end nodes 10) in any location 21 may be typical client computers, such as Personal Computers (PCs), workstations, Personal Digital Assistants (PDAs), digital mobile telephones, wireless network-enabled devices and the like. Additionally, the end nodes 10 may also be file servers, video set top boxes, other data processing machines, or indeed any other device capable of being networked from which messages are originated and to which message are destined.

Messages (or traffic) sent to and from the end nodes 10 typically take the form of data packets in the well known Internet Protocol (IP) packet format. As is well known in the art, an IP packet may encapsulate other networking protocols such as the Transmission Control Protocol (TCP), the User Datagram Protocol (UDP), or other lower level and higher level networking protocols.

Still referring to FIG. 1, in the example wide area data communications network 100, the Re-encrypting Policy Enforcement Points (R-PEPs) 20 cooperate with the Security Managers (SMs) 11, the Key Authority Points (KAPs) 14, the Policy Distribution Points (PDPs) 30, to secure message traffic between the end nodes 10 according to security policies.

Recall a security policy (or simply a “policy”) defines data (or “traffic”) to be secured by a source IP address, a destination IP address, a port number and/or a protocol. The security policy also defines a type of security to be performed on the traffic.

At each location 21 there is a Security Manager (SM) 11 (e.g., the SM 11-A at the location 21-A). Each SM 11 is a data processing device, typically a PC or a workstation, through which an administrative user inputs and configures security policies.

The SM 11 also acts as a secure server which stores and provides access to security policies by other elements or functions of the example wide area data communications network 100.

Each KAP function 14 is responsible for generating and distributing “secret data” known as encryption keys to a respective R-PEP function 20. For example, the KAP function 14-a generates and distributes keys to the R-PEP function 20-a. Further details of a preferred embodiment for generating and distributing encryption keys are contained in a co-pending U.S. Provisional Patent Application No. 60/756,765 entitled SECURING NETWORK TRAFFIC USING DISTRIBUTED KEY GENERATION AND DISSEMINATION OVER SECURE TUNNELS, filed Jan. 6, 2006, assigned to CipherOptics, Inc., and which is hereby incorporated by reference in its entirety.

Each PDP function 30 is responsible for distributing security polices to a respective R-PEP function 20. For example, the PDP 30-1 distributes security polices to the R-PEP 20-1. Further details of a preferred embodiment for distributing the security polices are contained in a co-pending U.S. Provisional Patent Application No. 60/813,766 entitled SECURING NETWORK TRAFFIC BY DISTRIBUTING POLICIES IN A HIERARCHY OVER SECURE TUNNELS, filed Jun. 14, 2006, assigned to CipherOptics, Inc., and which is hereby incorporated by reference in its entirety.

FIG. 1, by way of example, illustrates the SM function 11, the KAP function 14, and the PDP function 30 residing at each location 21. Alternatively, these functions may be centrally located (not shown). Furthermore, while the R-PEP function 20 is discussed in connection with the SM function 11, the KAP function 14, and the PDP function 30, such functions are not required. As will be discussed below, the R-PEP function 20 is independent of these functions and one skilled in the art will readily recognize the present invention is not limited by these functions.

Still referring to FIG. 1, the example network 100 has at least one Security Group (SG), generally 40, defined for each different locations 21-a and 21-b. Recall a SG is a collection of member end-nodes or subnets which are permitted to access or otherwise communicate with one another. Also recall a security policy may be configured with a SG and end nodes associated with that SG. Information regarding a SG may be maintained in a SM for a location (e.g., SM 11-a in the case of the location 21-a, and SM 11-b in the case of the location 21-b) or distributed by a centralized Authentication Server (not shown).

FIG. 1, by way of example, illustrates the end-node 10-a-1 in the location 21-A as part of a SG 40-1. The SG 40-1 also includes the end-node 10-a-2 in the location 21-a and the end node 10-b-2 in the location 21-b. A security policy (not shown) is created at the location 21-a to associate the end node 10-a-1 and the end node 10-a-2 to the SG 40-1. In a preferred embodiment disclosed in the co-pending patent application entitled MULTIPLE SECURITY GROUPS WITH COMMON KEYS ON DISTRIBUTED NETWORKS, information concerning membership of the end node 10-b-2 in the location 21-b need not be provided to the SM 11-a for the location 21-a. Instead another security policy (not shown) is created at the location 21-b associating the end node 10-b-2 to the SG 40-1. The security policy at the location 21-b need not specify end-nodes 10-a-1 and 10-a-2 on the local network 21-a.

For the sake of readability, the location 21-a is hereinafter referred to as a local network, and the location 21-b is hereinafter referred to as a remote network. As such, the R-PEP function 20 inter-networks the local network and the remote network. That is, a “local network side” of the R-PEP function 20 is networked to the local network 21-a and a “remote network side” of the R-PEP function 20 is networked to the remote network 21-b. The terms local network and Local Area Network (LAN) are used interchangeably throughout this disclosure. Similarly, the terms remote network and Wide Area Network (WAN) are used interchangeably throughout this disclosure.

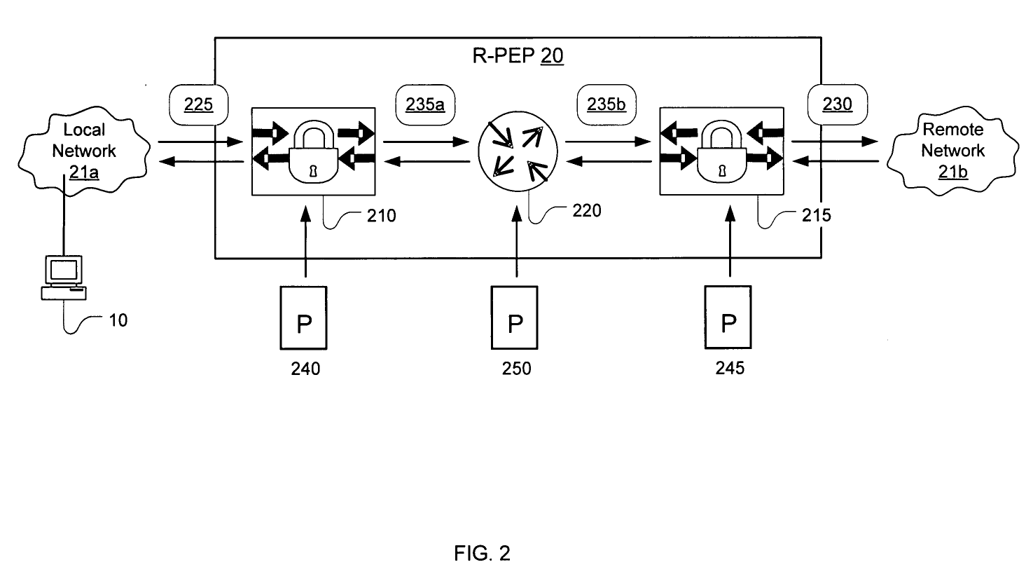

FIG. 2 illustrates an example Re-encrypting Policy Enforcement Point (R-PEP) function 20. The R-PEP function 20 is made up of three sub-functions: i) a Local Policy Enforcement Point (Local-PEP) sub-function 210, ii) a Remote Policy Enforcement Point (Remote-PEP) sub-function 215, and iii) an R-PEP Router sub-function 220.

In describing aspects of the present invention and its embodiments, the following terminology is used throughout this disclosure. Packets to and from the end-nodes 10 on the local network 21 a are hereinafter referred to as local packets 225. The “local packets” 225 may either be encrypted packets or unencrypted packets, i.e., packets which have not been encrypted. Packets to and from the remote network 21b are hereinafter referred to as “remote packets” 230. The remotes packets 230 may either be encrypted packets or unencrypted packets, i.e., packets which have not been encrypted. Packets sent to and from the R-PEP Router sub-function 220 are hereinafter referred to as “internal packets” 235a and 235b (generally 235). The internal packets 235 may either be unencrypted packets (i.e., packets which have not been encrypted) or be decrypted packets, i.e., packets previously encrypted. Furthermore, packets sent unencrypted are said to be “sent in the clear.”

The Local-PEP 210 of the R-PEP 20 secures or otherwise establishes local secure connections between end-nodes 10 on the local network 21a and the Local-PEP 210. The Local-PEP 210 uses local security policies 240 to establish local secure connections. In this way, the R-PEP 210 provides local network security. The Local-PEP 210 is loaded or is otherwise configured with the local security policies 240.

The Local-PEP 210 receives encrypted local packets 225 from the end-nodes 10 on the local network 21a. The Local-PEP 210 decrypts the encrypted local packets 225 based on the local security policies 240. The Local-PEP 210 sends the decrypted packets to the R-PEP Router 220 as the internal packets 235a.

The Local-PEP 210 also receives from the R-PEP Router 220 the internal packets 235a. Recall the internal packets 235 are either unencrypted or decrypted. The Local-PEP 210 sends the received internal packets 235a to the end-nodes 10 on the local network 21a as local packets 225. Depending on the local security policies 240, the Local-PEP 210 sends the local packets 225 to the end nodes 10 on the local network 21a as either encrypted or unencrypted packets.

The Remote-PEP 215 of the R-PEP 20 secures or otherwise establishes remote secure connections between the remote network 21b and the Remote-PEP 215. The Remote-PEP 215 uses remote security policies 245 to establish remote secure connections. In this way, the R-PEP 210 provides remote network security. The Remote-PEP 215 is loaded or otherwise configured with the remote security policies 245.

The Remote-PEP 215 receives encrypted remote packets 230 from the remote network 21b. The Remote-PEP 215 decrypts the encrypted remote packets 230 based on the remote security policies 245. The Remote-PEP 215 sends the decrypted packets to the R-PEP Router 220 as the internal packets 235b.

The Remote-PEP 215 also receives the internal packets 235b from the R-PEP Router 220. Recall the internal packets 235 are either unencrypted or decrypted. The Remote-PEP 215 sends the received internal packets 235b to the remote network 21b as remote packets 230. Depending on the remote security policies 245, the Remote-PEP 215 sends the remote packets 230 to the remote network 21b as either encrypted or unencrypted.

The R-PEP Router 220 of the R-PEP 20 routes or otherwise sends and receives the internal packets 235 to and from the Local-PEP 210 and the Remote-PEP 215. The R-PEP Router 220 uses routing security policies 250 to internally route and to make decisions regarding the internal packets 235. The R-PEP Router 220 is loaded or otherwise configured with the routing security policies 250.

The R-PEP Router 220 receives internal packets 235 from either the Local-PEP 210 or the Remote-PEP 215. Recall the internal packets 235 are either unencrypted or decrypted. The R-PEP Router 220 internally routes the received internal packets 235 to either the Local-PEP 210 or the Remote-PEP 215 based on the routing security policies 250. The R-PEP Router 220 also drops received internal packets 235 based on the routing security policies 250.

In contrast to IP routing, the embodiments of the present invention require the R-PEP Router 220 to make at least the following decisions regarding an internal packet (e.g., 235a): i) decide whether a source of the internal packet and a destination of the internal packet belong to a same security group, ii) decide whether the destination of the internal packet is on a local network (e.g. 21a) or a remote network (e.g., 21b), and iii) decide whether the destination of the internal packet allows unencrypted packets or traffic.

The example embodiment of FIG. 2 illustrates an R-PEP function inter-networked between networks, e.g., the local network 21a and the remote network 21b. One skilled in the art, however, will readily recognize the principles of present invention are not limited to such a configuration. For example, in one embodiment, an R-PEP is networked to a single network or subnet. As such, there is no “local” network and “remote” network per se. By way of example, on the subnet there is a first end node, a second end node and a third end node. The first and third end nodes belong to a first security group. The second end node belongs to a second security group. The R-PEP of this example handles a packet from the first end node to the third end node in substantially the same manner as described in reference to FIG. 2.

In particular, an Inbound-PEP of the R-PEP secures or otherwise establishes a secure inbound connection between the first end-node and the Inbound-PEP according to an inbound security policy. The Inbound-PEP receives an encrypted inbound packet from the first end node. The Inbound-PEP decrypts the encrypted inbound packet based on the inbound security policy. The Inbound-PEP sends the decrypted packet to an R-PEP Router as an internal packet.

The R-PEP Router internally routes the internal packet sent from the Inbound-PEP to an Outbound-PEP since the first end node and the third end node belong to a same security group. The Outbound-PEP secures or otherwise establishes a secure connection between the Outbound-PEP and the third end node according to an outbound security policy. An encrypted outbound packet is sent to the third end node.

In an event a source and a destination of the inbound packet do not belong to a same security group (e.g., a packet from the first end node to the second end node) the inbound packet, according to an outbound security policy, is either dropped or sent by the Outbound-PEP as an unencrypted outbound packet. Accordingly, the R-PEP of this example, secures packets sent to and from end nodes within a same security group of a single network to the exclusion of end nodes not within the same security group but are on the same single network.

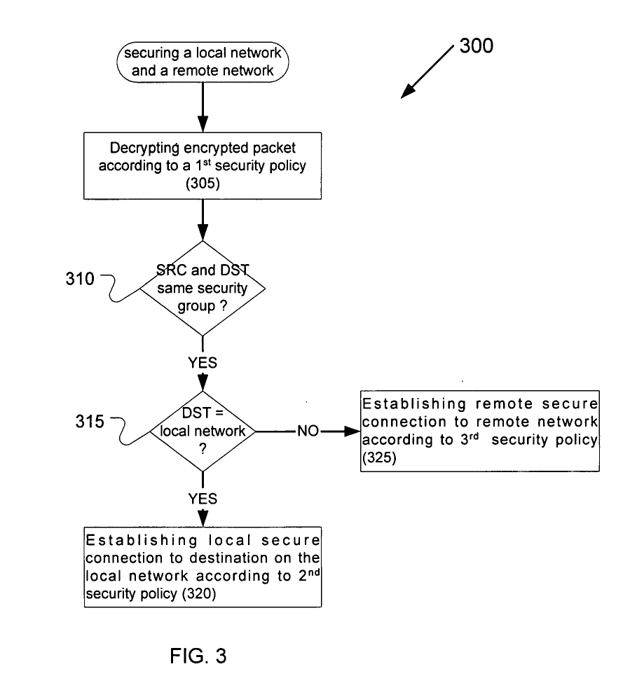

FIG. 3 illustrates an example process 300 for securing a local network and a remote network in accordance with an embodiment of the present invention. In step 305, an encrypted packet is decrypted according to a first security policy. In step 310, the process 300 determines whether a source of the decrypted packet and a destination of the decrypted packet belong to a same security group. In an event the source of the decrypted packet and the destination of the decrypted packet belong to the same security group, in step 315, the process 300 determines whether the destination of the decrypted packet is on the local network or on the remote network. In an event the destination of the decrypted packet is on the local network, the process 300 in step 320, establishes a local secure connection to the destination on the local network according to a second security policy. Alternatively, in an event the destination of the decrypted packet is on the remote network, the process 300 in step 325, establishes a remote secure connection to the remote network according to a third security policy.

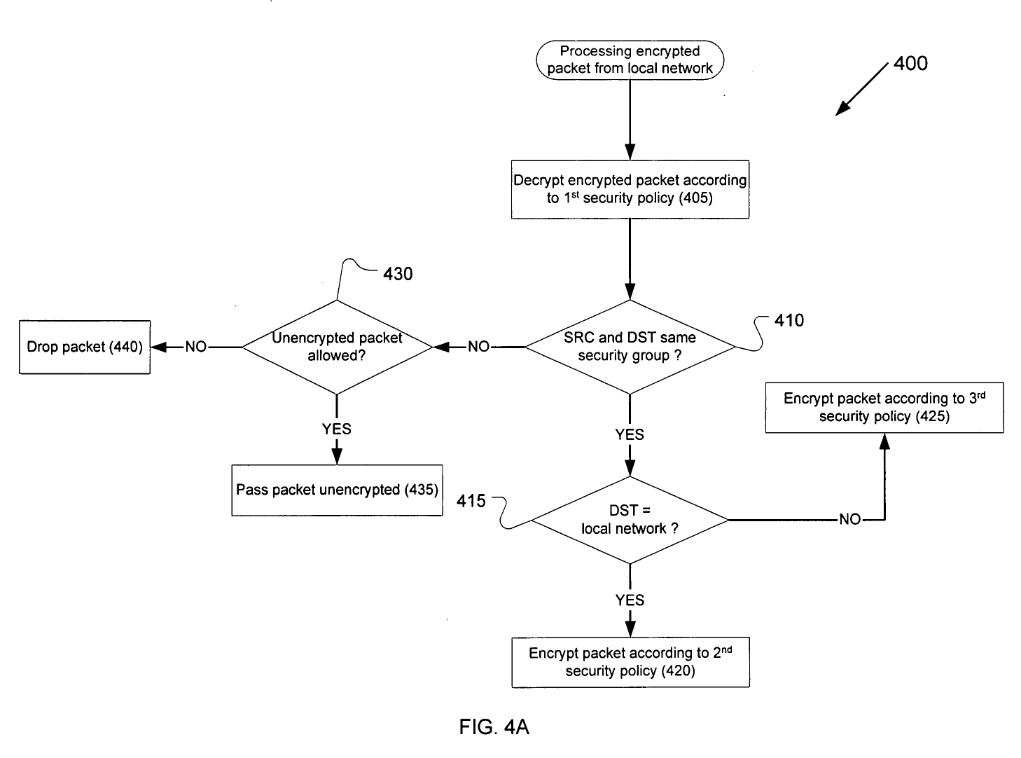

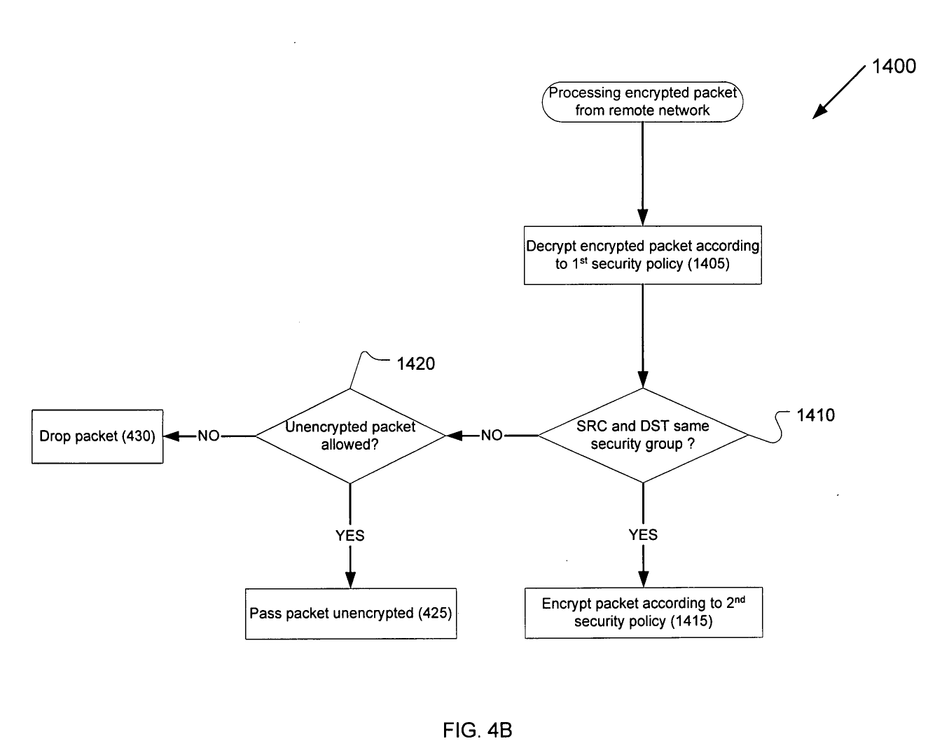

FIG. 4A illustrates an example R-PEP process 400 for processing an encrypted packet from a local network while providing local network security and remote network security. The R-PEP process 400 decrypts (step 405) the encrypted packet in accordance with a first security policy. The R-PEP process 400 decides (410) whether the source of the decrypted packet and the destination of the decrypted packet belong to a same security group. If the R-PEP process 400 decides (410) the source of the decrypted packet and the destination of the decrypted packet do belong to the same security group, then the R-PEP 400 decides (415) whether the destination of the decrypted packet is on the local network or a remote network.

If the R-PEP process 400 decides (415) the destination of the decrypted packet is on the local network, then the R-PEP process 400 encrypts (420) the packet in accordance with a second security policy. The second security policy establishes a local secure connection between the R-PEP process 400 and an end-node on the local network, thus providing local network security. If, however, the R-PEP process 400 decides (415) the destination of the decrypted packet is on the remote network, then the R-PEP process 400 encrypts (425) the packet in accordance with a third security policy. The third security policy establishes a remote secure connection between the R-PEP process 400 and the remote network, thus providing remote network security.

If the R-PEP process 400 decides (410) the source of the decrypted packet and the destination of the decrypted packet do not belong to the same security group, then the R-PEP process 400 decides (430) whether unencrypted packets are allowed on the local network in an event the destination of the packet is on the local network or whether unencrypted packets are allowed on the remote network in an event the destination of the packet is on the remote network. If the R-PEP process 400 decides (430) unencrypted packets are allowed, then the R-PEP process 400 does not encrypt the packet. The R-PEP process 400 simply passes (435) the packet to the destination without establishing a local secure connection to a local node on the local network or a remote secure connection to the remote network. If the R-PEP process 400 decides (430) unencrypted packets are not allowed on either the local network or the remote network, then the R-PEP process 400 drops (440) the packet.

FIG. 4B illustrates an example process 1400 for processing an encrypted packet from a remote network while providing local network security and remote network security. The R-PEP process 1400 decrypts (1405) the encrypted packet in accordance with a first security policy. The R-PEP process 1400 decides (1410) whether the source of the decrypted packet and the destination of the decrypted packet belong to a same security group. If the R-PEP process 1400 decides (1410) the source of the decrypted packet and the destination of the decrypted packet do belong to the same security group, then the R-PEP 1400 encrypts (1415) the packet in accordance with a second security policy. The second security policy establishes a remote secure connection between the R-PEP and an end-node on the local network.

If, however, the R-PEP process 1400 decides (1410) the source of the decrypted packet and the destination of the decrypted packet do not belong to the same security group, then the R-PEP process 1400 decides (1420) whether unencrypted packets are allowed on the local network. If the R-PEP process 1400 decides (1420) unencrypted packets are allowed, then the R-PEP process 1400 does not encrypt (1425) the packet. The R-PEP process 1400 simply passes the packet to the destination without providing a secure connection to an end node on the local network. If, however, the R-PEP process 1400 decides (1420) unencrypted packets are not allowed on the local network, then the R-PEP process 1400 drops (1430) the packet.

In reference to FIGS. 4A and 4B, it should be noted decisions by the R-PEP process (400 and 1400, respectively) are made based on one or more security policies. Embodiments of the present invention are not dependant on a particular number of security policies, nor is it significant. What is of significance, however, is that an R-PEP process enforces security policies which are configured or otherwise loaded into the R-PEP process. The enforced security policies are, in some instances, different from one another. In other instances, the enforced security policies are overlapping and provide a same security definition.

Furthermore, embodiments of the present invention do not depend on how an R-PEP process is configured or otherwise loaded with security policies. Again, what is of significance is that an R-PEP process enforces security policies which are configured or otherwise loaded into the R-PEP process. For example, in one embodiment, security policies for an R-PEP process are loaded by directly negotiating security policies using e.g., Internet Key Exchange (IKE). In another embodiment, security polices for an R-PEP process are configured by distributing security policies using a security policy and key distribution system. Such system is described in detail in the U.S. Provisional Patent Application No. 60/813,766 entitled SECURING NETWORK TRAFFIC BY DISTRIBUTING POLICIES IN A HIERARCHY OVER SECURE TUNNELS, filed Jun. 14, 2006, assigned to CipherOptics, Inc, and the U.S. Provisional Patent Application No. 60/756,765 entitled SECURING NETWORK TRAFFIC USING DISTRIBUTED KEY GENERATION AND DISSEMINATION OVER SECURE TUNNELS, filed Jan. 6, 2006, assigned to CipherOptics, Inc.

In still another embodiment, security polices for an R-PEP process are made by both directly negotiating the security policies, and distributing the security policies through a policy and key distribution system. In this embodiment, the R-PEP process assigns a security group or security groups to an end node on a local network. In this way, communication with a remote network proceeds under either a security group concept or under an administrative-based policy definition. Consider the following example.

A first end node on a local network negotiates a security policy with an R-PEP. The R-PEP, interoperating with a directory service (i.e., a service which automates network management of user data, security, and distributed resources), negotiates a first security policy which assigns the end node to an “accounting security group.” A second security policy for establishing an “accounting secure network connection” between the R-PEP and a remote network is distributed, via a policy and key distribution system, to the R-PEP. Consequently, the first end node on the local network communicates with members of the accounting'security group, which are located on the remote network, using the accounting secure network connection. A second end node negotiates a third security policy, but is assigned to an “engineering security group.” Since the second end node is not a member of the accounting security group, the second end node cannot use the accounting secure network connection to communicate with end nodes on the remote network. Instead, the second end node communicates with members of the engineering security group, which are located on the remote network, using an “engineering secure network connection,” which is established according to fourth security policy distributed, via the policy and key distribution system, to the R-PEP.

In this way, embodiments of the present invention isolate management of end nodes on a local network from management of end nodes on a remote network while providing local and remote network security. Moreover, embodiments of the present invention layer onto and leverage existing network infrastructure.

While this invention has been particularly shown and described with references to preferred embodiments thereof, it will be understood by those skilled in the art that various changes in form and details may be made therein without departing from the scope of the invention encompassed by the appended claims.

For example, in one embodiment, a process determines whether a decrypted packet belongs to a same security group based on a source of a decrypted packet. In this embodiment, the determination is made with a set of security policies for each source within a security group. In another embodiment, a process tags or otherwise assigns a security group to a decrypted packet. In this way, a security policy is associated with a tag or an assignment rather than a source of the decrypted packet.

What is claimed is:

1. A network security method for providing local network security and remote network security comprising:
decrypting an encrypted packet according to a first security policy to yield a decrypted packet;
establishing a local secure connection to an end node on a local network according to a second security policy in an event a source of the decrypted packet and a destination of the decrypted packet belong to a same security group, and the destination of the decrypted packet is on the local network; and
establishing a remote secure connection to a remote network according to a third security policy in an event the source of the decrypted packet and the destination of the decrypted packet belong to a same security group, and the destination of the decrypted packet is the remote network.

2. The method of claim I wherein the establishing the local secure connection to the end node includes encrypting the decrypted packet with a set of local security parameters.

3. The method of claim 1 wherein the establishing the remote secure connection to the remote network includes encrypting the decrypted packet with a set of remote security parameters.

4. The method of claim 1 further comprising dropping the decrypted packet in an event the source of the decrypted packet and the destination of the decrypted packet belong to different security groups, and a network only allows encrypted packets.

5. The method of claim 1 further comprising:
passing the decrypted packet unencrypted to the end-node on the local network in an event the source of the decrypted packet and the destination of the decrypted packet belong to different security groups, and the local network allows unencrypted packets; and
passing the decrypted packet unencrypted to the remote network in an event the source of the decrypted packet and the destination of the decrypted packet belong to different security groups, and the remote network allows unencrypted packets.

6. The method of claim 1 further comprising negotiating security policies.

7. The method of claim 6 wherein the negotiating includes exchanging security policies using Internet Key Exchange (IKE).

8. The method of claim 1 further comprising distributing security policies.

9. The method of claim 8 wherein the distributing includes configuring security policies using a policy and key distribution system.

10. The method of claim 1 further comprising assigning the decrypted packet to a security group.

11. The method of claim 10 wherein the assigning includes tagging the decrypted packet with a Virtual Local Area Network (VLAN) tag.

12. A network security apparatus for securing a local network and a remote network comprising:
a de-encryptor which decrypts an encrypted packet to yield a decrypted packet;
a local securer communicatively coupled to the de-encryptor which establishes a secure connection to an end node on a local network according to a first security policy in an event a source of the decrypted packet and a destination of the decrypted packet belong to a same security group, and the destination of the decrypted packet is on the local network; and
a remote securer communicatively coupled to the de-encryptor which establishes a secure connection to a remote network according to a second security policy in an event the source of the decrypted packet and the destination of the decrypted packet belong to a same security group, and the destination of the decrypted packet is the remote network.

13. The apparatus of claim 12 wherein the local securer is a local policy enforcement point.

14. The apparatus of claim 13 wherein the local policy enforcement point encrypts the decrypted packet with a set of local security parameters.

15. The apparatus of claim 12 wherein the second securing unit is a remote policy enforcement point.

16. The apparatus of claim 15 wherein the remote policy enforcement point encrypts the decrypted packet with a set of remote security parameters.

17. The apparatus of claim 12 further comprising a router which drops the decrypted packet in an event the source of the decrypted packet and the destination of the decrypted packet belong to different security groups, and a network only allows encrypted packets.

18. The apparatus of claim 12 further comprising a router which i) passes the decrypted packet unencrypted to the end-node on the local network in an event the source of the decrypted packet, and the destination of the decrypted packet belong to different security groups and the local network allows unencrypted packets, and ii) passes the decrypted packet unencrypted to the remote network in an event the source of the decrypted packet and the destination of the decrypted packet belong to different security groups, and the remote network allows unencrypted packets.

19. The apparatus of claim 12 further comprising a security policy loader which negotiates security policies in an event Internet Key Exchange (IKE) is used, and distributes security policies in an event a policy and key distribution system is used.

20. A computer program product comprising a computer usable medium having a computer usable program code for providing local network security and remote network security, the computer program product including;
computer useable program code for decrypting an encrypted packet according to a first security policy to yield a decrypted packet;
computer useable program code for establishing a local secure connection to an end node on a local network according to a second security policy in an event a source of the decrypted packet and a destination of the decrypted packet belong to a same security group, and the destination of the decrypted packet is on the local network; and
computer useable program code for establishing a remote secure connection to a remote network according to a third security policy in an event the source of the decrypted packet and the destination of the decrypted packet belong to a same security group, and the destination of the decrypted packet is the remote network.
